(19) United States
(12) Patent Application Publication
(10) Pub. No.: US 2003/0227873 A1
(43) Pub. Date: Dec. 11, 2003

(54) Method and apparatus for switching between a wireless local area network (WLAN) and a wide area network (WAN) employing operator and user criteria

(75) Inventor: Steven Jeffrey Goldberg, Downingtown, PA (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/452,104

(22) Filed: Jun. 2, 2003

Related U.S. Application Data
(60) Provisional application No. 60/385,871, filed on Jun. 5, 2002.

(51) Int. Cl. H04L 1/00

(52) U.S. Cl. 370/235; 370/252

(57) ABSTRACT

Method and apparatus for controlling switching between a first network such as a wireless local area network (WLAN) and a second network such as a wide area network (WAN) utilizing fuzzy logic in which input data constituting factors in determining the propriety of a switching operation undergoes a fuzzification process wherein inputs are sorted into membership values with associated linguistic variables. A rules engine operates on the membership values generating output membership data which then undergoes “defuzzification” to produce an actionable result.

### CROSS REFERENCE TO RELATED APPLICATION(S)

This application claims priority from Serial No. 60/385,871 filed on Jun. 5, 2002, which is incorporated by reference as if fully set forth.

### FIELD OF THE INVENTION

The present invention relates to WLAN-WAN switching. More particularly, the present invention relates to method and apparatus to facilitate such switching taking into account both operator and user criteria and perspective.

### BACKGROUND

User and service operators have conflicting perspectives as to the optimum utilization of link resources in a communication system. For example, a user, from his perspective, desires to have the cheapest and yet highest quality of service (QoS) available. On the other hand, from the perspective of the service operator there is typically a desire to provide the cheapest or least expensive service and to provide adequate QoS and security to keep most of its subscribers happy. In addition to a conflict of objectives as between the service operator and the user, there are actually conflicts within each of these groups as to their desires. For example, the lowest cost for the user may not be very secure. Likewise “adequate QoS” to support a user application may not be optimum to achieve an overall goal of revenue maximization from the point of view of the service provider.

Present day systems are limited to making fixed triggering assumptions about whether a transfer should be made between systems. Such fixed assumptions as to when to switch and not switch are usually placed on a few specific simulations of expected operational scenarios. While such switching decisions are adequate when the systems are lightly loaded or when the network is operating close to a scenario that has been modeled, such fixed assumptions do not take into account the myriad of other scenarios that will occur in real systems as loading and service applications evolve.

One typical method for selecting a link involves determining exact mathematical relationships between inputs and outputs and their complicated relationships. However, when a parameter falls outside of the boundaries of the equations employed, the system can become very inefficient and in the worst case the network may become unstable due, for example, to excessive switching and very low resource utilization. Adjustments to maintain the stability of the system and strive towards some optimization goals is very complicated and time consuming, necessitating a decision making process that is inherently stable, sensitive to both changing and unforeseen states and is easily modified when necessary.

### SUMMARY

These attributes are accomplished through the provision of method and apparatus for controlling switching between WLANs and WANs which is implemented in a fuzzy logic design in which input data undergoes a fuzzification process, sorting inputs into membership values with associated linguistic variables. A rules engine operates on the membership values generating output membership data. The output of the rules engine then undergoes “defuzzification” to produce an actionable result.

### BRIEF DESCRIPTION OF THE FIGURES

The present invention and its objectives and its advantages will be best understood from a consideration of the following figures in which like elements are designated by like numerals, and wherein:

FIG. 1 is a block diagram of a device employing a fuzzy logic design and embodying the principles of the present invention.

FIG. 2 is a plot of showing in relationship the membership function to usable in present network and usable in possible network.

FIG. 3 is a plot of relationship of membership function to cost to user and cost to network.

FIG. 4 is a plot relating membership function to usability need to switch.

### DETAILED DESCRIPTION OF THE INVENTION AND THE PREFERRED EMBODIMENTS THEREOF

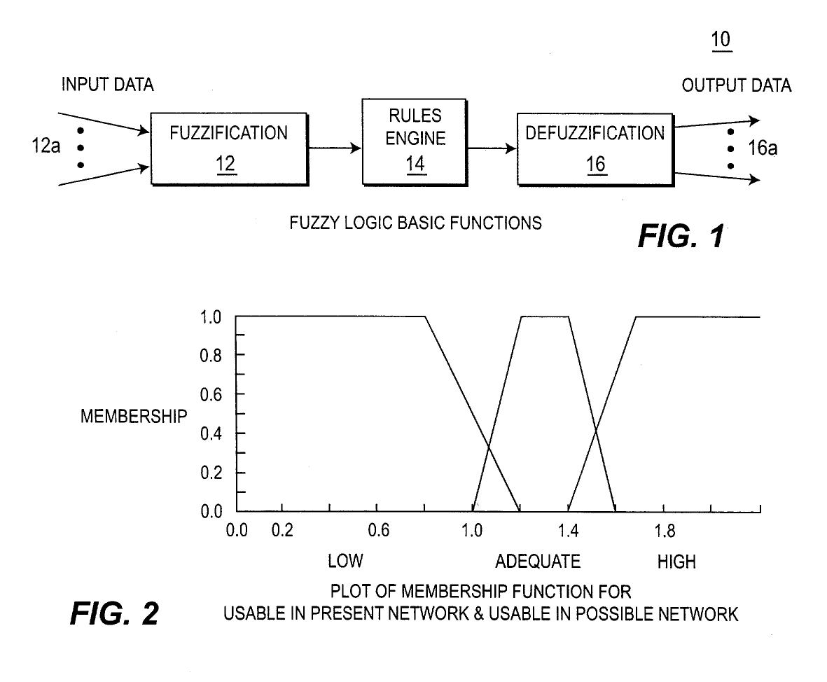

FIG. 1 is a block diagram of a fuzzy logic design system for effecting the decision making process, such as switching between a network “A” and a network “B”.

Input data enters into the fuzzification process at stage 12. Typical input data, entered at 12a, includes but, is not limited to, the following types of information:

Application quality of service (QoS) requirement, for example, latency, fidelity, security.

User service subscription particulars, for example, including: priority, incremental costs.

The state of network A, for example, loading and cost for QoS required.

The state of network B, which may incorporate substantially the same type of criteria as the state of network A.

The cost of switching from the present network, for example, network A, to another network, for example, network B, such cost including, for example, delay in application execution and insufficiencies in channel utilizations during transition.

The input data enters the fuzzification process at stage 12 which sorts the inputs into membership values with associated linguistic variables. The input data may be stored in storage means (not shown) associated with stage 12 to compare current and historic values, for example.

FIG. 2 shows input membership sets which include:

usable in present network

usable in possible network

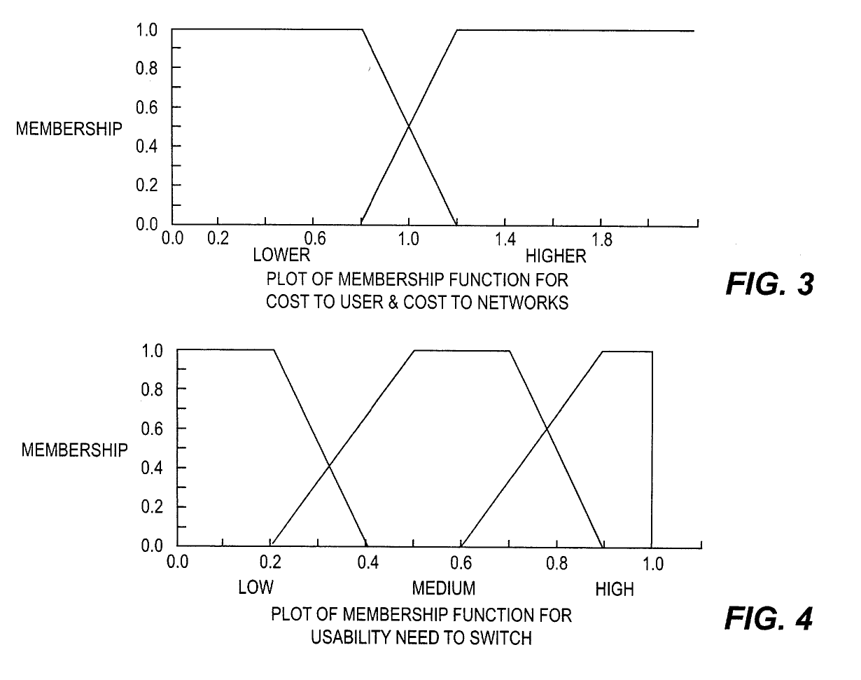

Regarding the costs to user, FIG. 3 shows the ratio of present to possible cost to networks. Regarding cost to networks, FIG. 3 also shows the ratio of present to possible.

The rules engine 14 operates on the membership values, generating output membership data. FIG. 4 shows the usability need to switch.

The following rules are examples of the rules engine 14: (typically referred as linguistic rules).

Initialize rules results assume usability need to switch is low.

Rules applied:

If (usable In Present Network is low (FIG. 2) AND usable In Possible Network is adequate or high (also FIG. 2)) THEN usability need to switch is high.

If (usable In Present Network is adequate AND usable In Possible Network is high) THEN usability need to switch is medium.

The output of rules Engine 14 is then passed through the “Defuzzification” process at stage 16 to produce an actionable result, at 16a.

The following is one example:

Initialize decision

Switch decision IS no (a crisp binary variable of set {yes, no})

Determine if decision should be set to yes

IF (usability Need To Switch IS high) THEN switch decision IS yes; EXIT

IF (usability Need To Switch IS medium)

IF (Cost To User IS Lower OR Cost To Networks IS lower) THEN switch decision IS yes; EXIT

ELSE not a cost benefit to either one EXIT

ELSE usability Need To Switch IS low IF (Cost To User IS lower AND control network is lower) THEN Switch Decision IS yes; EXIT ELSE number not a cost benefit for both; EXIT

The membership sets and rules outlined above are examples of the possibilities. Fuzzy logic facilitates use of additional inputs, rules, and outputs in a straight-forward manner, leading to rapid enhancement of the systems operation as required.

This type of system also lends itself to providing the users and system operators both with the means to determine the most important characteristics of operations to each of them. Even though these goals may be in conflict, the proper set up of the membership functions lead to reasonable and stable operation of the system.

What is claimed is:

1. A method for switching between first network and a second network, comprising:
a) identifying and obtaining a plurality of inputs for use in making a switching determination, said inputs being selected from the group consisting of: application quality of service (QoS) requirement, user service subscription particulars, state of the first network, state of the second network, cost of switching from that network presently connected, for example, the first network, to another network, for example, the second network;
b) sorting the identified inputs obtained at step (a) into membership values having an associated linguistic variable;
c) providing output membership data based on said membership values;
d) providing a control output based on the output obtained at step (c); and
e) performing step (d) responsive to a request for a switching operation.

2. The method of claim 1 further comprising:
f) making a switching determination responsive to an output obtained at step (d).

3. The method of claim 1 wherein step (a) further includes selecting the application QoS requirement which includes latency, fidelity and security.

4. The method of claim 1 wherein step (a) further includes selecting service subscription particulars including priority and incremental costs.

5. The method of claim 1 wherein step (a) further includes selecting, for each of the states of the first and second networks, loading and cost for a desired QoS.

6. The method of claim 1 wherein step (a) further includes, among the cost of switching, inputs including delay in application execution and insufficiencies in channel utilization during transition.

7. The method of claim 1 wherein step (a) further comprises storing the inputs and; step (e) further comprises making a switching determination further based on a comparison of stored historic inputs and current inputs.

8. Apparatus for determining the propriety of switching from a first to a second network, comprising:
a) means for receiving input relating to input conditions of said first and second networks;
b) a fuzzifier for generating membership values having linguistic variables based on current input conditions which are factors in determining the propriety of performing a switching operation;
c) a rules stage for applying a set of predetermined rules to the current input conditions from said fuzzifier to obtain output membership data; and
d) a defuzzifier responsive to said rules stage for generating a non-fuzzy prediction recommending a given switching operation.

9. The apparatus of claim 8 further comprising:
a controller performing an operation determined by said defuzzifier responsive to a switching request.

10. The apparatus of claim 8 wherein said means for receiving further comprises:
means for storing inputs; and
said fuzzifier including means for comparing stored inputs with current inputs to further aid in generating said membership values.

11. The apparatus of claim 8 wherein the input data includes inputs being selected from the group consisting of: application quality of service (QoS) requirement, user service subscription particulars, state of the first network, state of the second network, cost of switching from that network presently connected, for example, the first network, to another network, for example, the second network.

12. The apparatus of claim 11 wherein the QoS requirement further includes selecting application QoS requirement such as latency, fidelity and security.

13. The apparatus of claim 11 wherein the user service subscription particulars include priority and incremental costs.

14. The apparatus of claim 11 wherein selecting, for the state of the networks, includes loading and cost for a desired QoS.

15. The apparatus of claim 11 wherein the inputs further include, among the cost of switching, inputs including delay in application execution and insufficiencies in channel utilization during transition.

16. Apparatus for switching between a first network and a second network, comprising:
means for identifying and obtaining a plurality of inputs for use in making a switch determination, said inputs being selected from the group consisting of: application quality of service (QoS) requirement, user service subscription particulars, state of the first network, state of the second network, cost of switching from that network presently connected, for example, the first network, for example, the second network;
means for sorting the identified inputs obtained at step (a) into membership values having an associated linguistic variable;
means for providing output membership data based on said membership values;
means for providing a control output based on said membership values; and
means for enabling said means for providing responsive to a request for a switching operation.

17. The apparatus of claim 16 further comprising:
means for making a switching determination responsive to said means for providing.

18. The apparatus of claim 16 wherein said means for identifying further comprises:
means for selecting the application QoS requirement which includes latency, fidelity and security.

19. The apparatus of claim 16 wherein said means for identifying further comprises:
means for selecting service subscription particulars including priority and incremental costs.

20. The apparatus of claim 16 wherein said means for identifying further comprises:
means for selecting, for each of the states of the first and second networks, loading and cost data for a desired QoS.

21. The apparatus if claim 16 wherein said means for identifying further comprises:
among the cost of switching, inputs including delay in application execution and insufficiencies in channel utilization during transition.

22. The apparatus of claim 16 wherein said means for identifying further comprises:
means for storing the inputs; and
said means for making a switching determination being further based upon a means for comparison of stored historic inputs and current inputs.
